(19) United States
(12) Patent Application Publication
(10) Pub. No.: US 2018/0268790 A1
(43) Pub. Date: Sep. 20, 2018

(54) DRUM RACK

(71) Applicants: Kevin Rhue, Huntington Beach, CA (US); Eric Meyer, Huntington Beach, CA (US)

(72) Inventors: Kevin Rhue, Huntington Beach, CA (US); Eric Meyer, Huntington Beach, CA (US)

(21) Appl. No.: 15/926,694

(22) Filed: Mar. 20, 2018

Related U.S. Application Data
(60) Provisional application No. 62/474,066, filed on Mar. 20, 2017.

(51) Int. Cl. G10D 13/02

(52) U.S. Cl. CPC G10D 13/026

(57) ABSTRACT

A rack for a drum set, comprising a X-shaped support member, wherein said X-shaped support member further comprises an upper partial X-shaped member and a lower partial X-shaped member; and further wherein, said upper partial X-shaped member contains at least one outwardly curving portion, and wherein said lower partial X-shaped member contains at least one outwardly curving portion, and one or more support legs, which may be removably coupled to said upper partial X-shaped member via a first sleeve coupled and to lower X-shaped member via a second sleeve.

### PRIORITY

This applications claims the priority date of provisional application No. 62/474,066 filed on Mar. 20, 2017, which is herein incorporated by reference in its entirety.

### BACKGROUND

The present disclosure relates generally to a drum rack, and more particularly, to a drum rack or bass rack for single or double bass standard drum sets.

Drum racks in the industry typically are configured similar to a scaffolding structure to which a user may connect his or her drum set. These drum racks typically have pieces that are positioned horizontally and/or vertically in nature, and have several joint pieces, including at perpendicular angles, which can absorb the force from a drum set and contribute to offset movements, sliding, twisting, slipping of drum clamps, and other disrupting actions. Such actions/movements are unfavorable for a drum player when a drum set is being played, or otherwise in use, as a drum player requires stability in the placement of a drum set and each of its pieces. Therefore, there is a need in the art for a drum rack that does not cause instability in the placement of a drum set, that effectively displaces the force from the drum set to a ground or floor area, and that requires minimal set-up pieces and procedures.

### SUMMARY

A single bass drum rack may be used in connection with a drum set. The single bass drum rack may comprise X-member, a first leg member, and a second leg member, such leg members which may be situated to the left and right sides of a bass drum of a drum set. The X-member may be situated in front of the frontward face of the bass drum. A user may use standard rack clamps, mounting hardware, and other connectors to connect the drum set pieces to the single bass drum rack.

A double bass drum rack that may be used with a drum set. Double bass drum rack may comprise a left X-member that may be positioned in front of a left bass drum, and a right X-member that may be positioned in front of a right bass drum. A left leg member of left X-member may be situated on the left hand side of a left bass drum, and right leg member of right X-member may be situated on the right hand side of a right bass drum. A user may use standard rack clamps, mounting hardware, and other connectors to connect other pieces of the drum set pieces to double bass drum rack according to a user's preference in placement of their drum set.

A rack for a single bass drum set, comprising a X-shaped support member; wherein said X-shape support member further comprises an upper partial X-shaped member and a lower partial X-shaped member; and further wherein, said upper partial X-shaped member contains at least one outwardly curving portion, and wherein said lower partial X-shaped member contains at least one outwardly curving portion; a first support leg removably coupled to said upper partial X-shaped member via a first sleeve coupled to said upper partial X-shaped member; and a second support leg removably coupled to said lower X-shaped member via a second sleeve coupled to said lower X-shaped member.

A rack for a double bass drum set, comprising a first X-shaped support member; wherein said first X-shaped support member further comprises a first upper partial X-shaped member and a first lower partial X-shaped member; and further wherein, said first upper partial X-shaped member contains at least one outwardly curving portion, and wherein said first lower partial X-shaped member contains at least one outwardly curving portion; and a first support leg removably coupled to said first partial lower X-shaped member via a first sleeve coupled to said first lower X-shaped member; a second X-shaped support member; wherein said second X-shaped support member further comprises a second upper partial X-shaped member, and a second lower partial X-shaped member; and further wherein, said second upper partial X-shaped member contains at least one outwardly curving portion, and wherein said second lower partial X-shaped member contains at least one outwardly curving portion; and a second support leg removably coupled to said second upper partial X-shaped member via a second sleeve coupled to said second upper X-shaped member.

### BRIEF DESCRIPTION OF THE SEVERAL VIEWS OF THE DRAWINGS

FIGS. 1A-C illustrate front, back, and side views of an embodiment of a drum rack for a single bass drum set;

FIG. 2 illustrates an embodiment of a drum rack for a single bass drum set as may be used with a drum set;

FIGS. 3A-C illustrate front, back, and side views of an embodiment of a drum rack for a double bass drum set;

FIG. 4 illustrates an embodiment of a drum rack for a double bass drum set shown in use with a drum set;

FIG. 5 illustrates a disassembled view of an embodiment of a drum rack for a single bass drum set;

FIG. 6 illustrates a disassembled view of an embodiment of a drum rack for a double bass drum set; and

FIGS. 7A-B illustrates a close-up view of an embodiment of a pin clip in an open and closed position for use with a drum rack for a single or double bass drum set.

### DESCRIPTION OF THE PREFERRED EMBODIMENTS

The detailed descriptions set forth below in connection with the appended drawings are intended as a description of embodiments of the invention, and is not intended to represent the only forms in which the present invention may be constructed and/or utilized. The descriptions set forth the structure and the sequence of steps for constructing and operating the invention in connection with the illustrated embodiments. It is to be understood, however, that the same or equivalent structures and steps may be accomplished by different embodiments that are also intended to be encompassed within the spirit and scope of the invention.

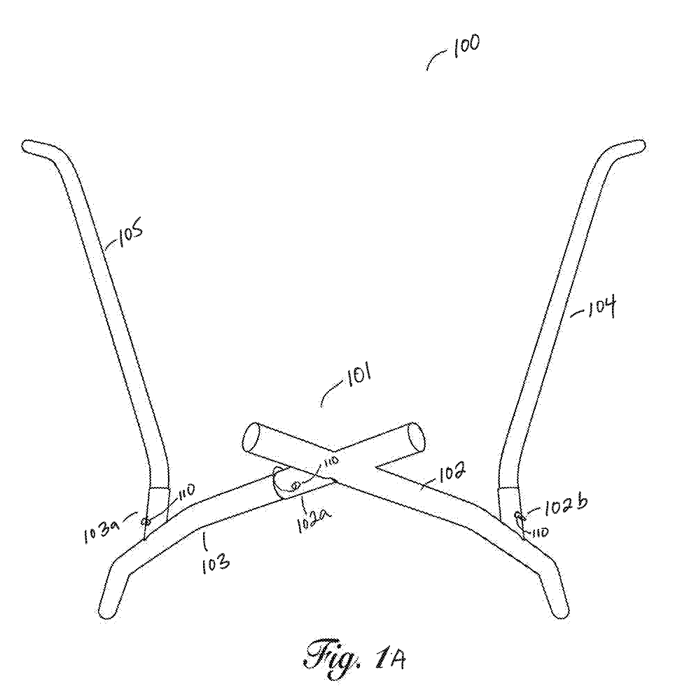

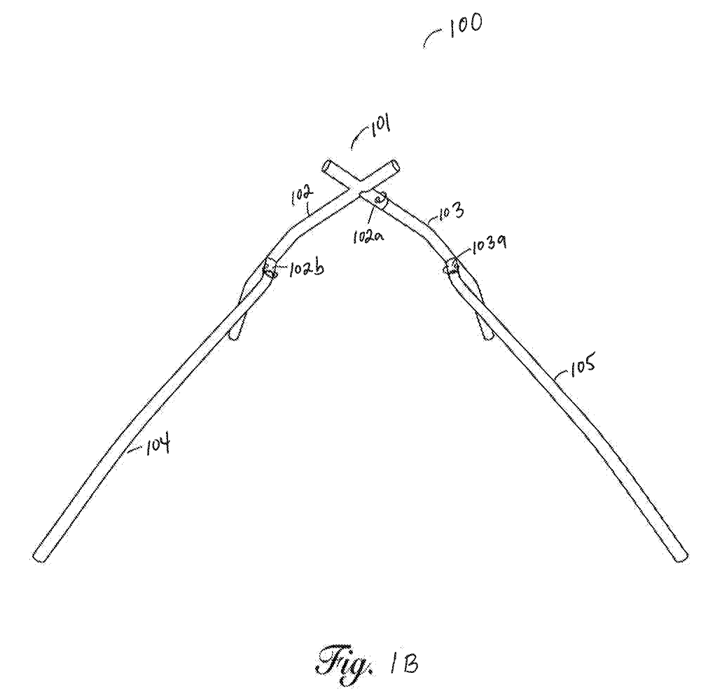

FIGS. 1A-C illustrate front, back, and side views of an embodiment of a drum rack for a single bass drum set (100). Single bass drum set (100) may be comprised of a generally X-shaped member, namely, X-member (101). The intersection portion of X-member (101) that forms the “X” section of X-member (101) may intersect toward an upper length of each leg of X-member (101) (as shown in FIGS. 1A-C). X-member (101) may be comprised of two pieces, namely, a first sub-member (102), or upper partial X-shaped member, that may be comprised of a leg of the X-shape of X-member (101) including the intersecting portion of the “X” shape, and second sub-member (103), or lower partial X-shaped member, which may be comprised of the remaining leg forming the overall X-shape of X-member (101) (See also FIG. 5 for additional details).

As noted, first sub-member (102) may be comprised of a leg of the X-shape as well as the intersecting portion forming the “X” shape, and may be further comprised of a first sleeve (102a) and a second sleeve (102b). First sleeve (102a) is configured to hold a proximal end of second sub-member (103), so that second sub-member (103) may be inserted therein. Second sub-member (103) further comprises a sleeve (103a). Both second sleeve (102b) and sleeve (103a) may extend laterally out from first sub-member (102) and second sub-member (103), respectively. Further, second sleeve (102b) is configured to hold a first leg member (104), and sleeve (103a) is configured to hold a second leg member (105).

Single bass drum rack (100) may be comprised of a tubular shaped material, which may be hollow in nature, and the exemplary embodiment of single bass drum rack (100) may largely be comprised of tubular steel and Chromalloy materials. Further, in the exemplary embodiment, each portion where a sleeve (including 102a, 102b, and 103a) is located may be comprised of Chromalloy, which may be welded to the tubular steel that forms the remaining sections of single bass drum rack (100). Chromalloy may be used to form sleeves due to its properties such as enhanced strength and hardness of material.

Both first sub-member (102) and second sub-member (103) of X-member (101) are angled/slanted in nature, and in an exemplary embodiment, may be positioned at an angle generally positioned at 45 degrees. First sub-member (102) and second sub-member (103) may be contoured in shape on a distal portion extending away from the intersecting “X” portion of X-member (101).

Further, each component of single bass drum rack (100) may all be angled (or slanted) in position. The slanted angles of each component may allow for the force from the drum set to be efficiently displaced to the ground or floor through first sub-member (102), second sub-member (103), first leg member (104), and second leg member (105). As single bass drum rack (100) may not be comprised of any cross-bar (for example, a completely horizontal cross-bar), this further allows for forces from the drum set to be directed down to the ground/floor via first sub-member (102), second sub-member (103), first leg member (104), and second leg member (105). However, variations of differing angles, slants, curvatures, including lengths and widths of the same, may be utilized in connection with the drum racks (100) and (200) (as further described below) without deviating from the scope of the present invention. Further, the enhanced displacement of force through drum rack (100) may eliminate sliding, twisting, and/or ancillary forward or lateral movements in the single bass drum rack (100) and the drum set pieces connected thereto.

First leg member (104) and second leg member (105) may also be contoured in shape and when coupled to sleeves (102b) and (103a), respectively, may extend laterally out from sleeves to support X-member (101) in an upright position. First leg member (104) may be further coupled to second sleeve (102b) by use of a pin clip (110). First leg member (104) may contain two circular openings (not shown) that line up with each other on opposite sides of a width of first leg member (104) that is inserted into second sleeve (102b). Similarly, second sleeve (102b) may also contain two circular openings (not shown) that line up with each other on opposite sides of its width that houses first leg member (104).

Also similar, second sub-member (103) may contain two circular openings (not shown) that line up with each other on opposite sides of a width of second sub-member (103) that is inserted into first sleeve (102a). First sleeve (102a) may also contain two circular openings (not shown) that line up with each other on opposite sides of its width that houses second sub-member (103). Furthermore, second leg member (105) may also contain two circular openings (not shown) that line up with each other on opposite sides of a width of second leg member (105) that is inserted into sleeve (103a). Sleeve (103a) also may contain two circular opening (not shown) that line up with each other on opposite sides of its width that houses second leg member (103).

When first leg member (104) is inserted into second sleeve (102b), second sub-member (103) into first sleeve (102a), and second leg member (105) into sleeve (103a), each of their respective circular openings are lined up so that pin clips (110) may be inserted there through to hold each of first leg member (104), second leg member (105), and second sub-member (102a) into their respective sleeves (102a, 102b, and 103a). Pin clips (110) may be used as another fastening piece to ensure that drum rack (101) is held in place when in use with a drum set and subject to varying levels of force.

Pin clips (110) may be comprised of a metal material, or other durable material (including plastic materials) that can hold each piece of drum rack (100) in place as well as withstand vibrations from a drum set in use as well as spring steel material, such as those known in the industry, for the clip portion of pin clip (110).

In an exemplary embodiment of single bass drum rack (100), X-member (101) may have a length of 44.5 inches, and a height (measured along first sub-member (102)) of 48 inches. The length above the intersecting portion of the “X” shape of X-member (101) may be 6 inches, and the height measured from the intersection portion of the “X” shape of X-member (101) to the ground may be 33 inches. Further, the measurement beginning at X-member (101) to the length of either first or second leg members (104, 105) may be 56 inches.

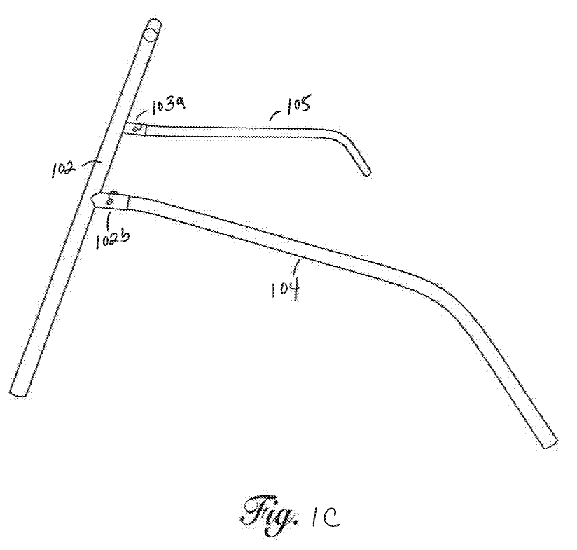

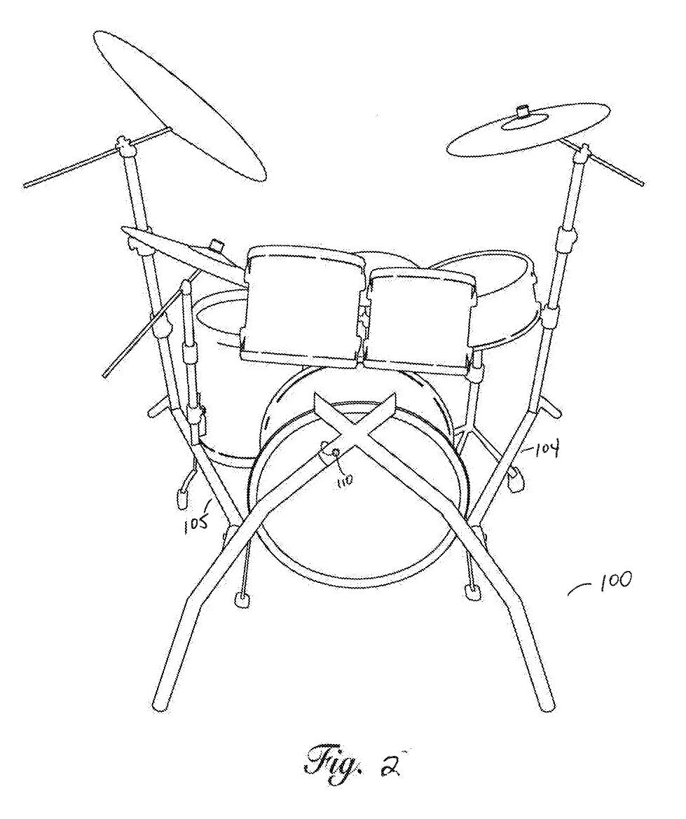

FIG. 2 illustrates the single bass drum rack (100) as may be used in connection with a drum set. First leg member (104) and second leg member (105) may be situated to the left and right sides of a bass drum of a drum set; X-member (101) may be situated in front of the frontward facing side of the bass drum. A user may use drum clamps and other drum connectors known in the industry to connect other pieces of the drum set to drum rack (100) according to a user's preference in placement of the drum set. For example, a user may connect other drum pieces to X-member (101), first leg member (104), and/or second leg member (105).

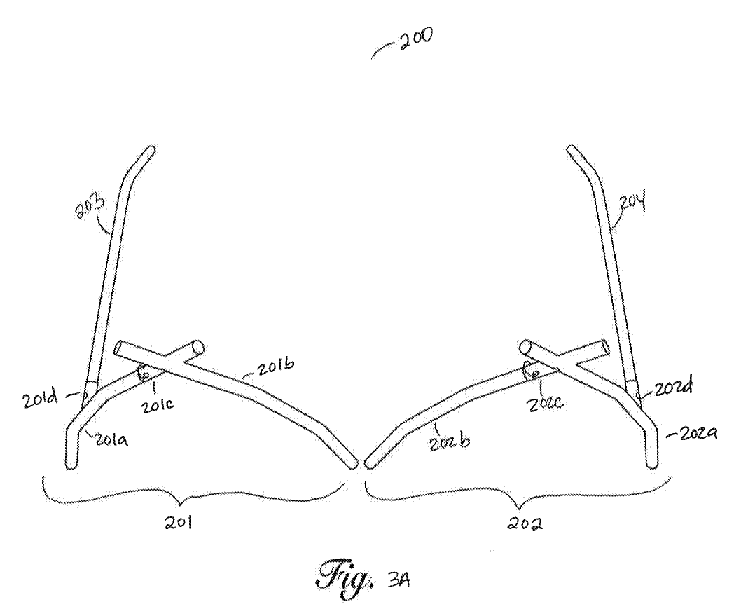

FIGS. 3A-C illustrate front, back, and side views of an embodiment of a drum rack for a double bass drum set (200). Double bass drum rack (200) may be comprised of a left X-member (201) and a right X-member (202). Left X-member (201) may be comprised of a first left sub-member (201a), or lower partial X-shaped member, and second left sub-member (201b), or upper partial X-shaped member. Second left sub-member (201b) may be further comprised of a first left sleeve (201c). First left sub-member (201a) may be comprised of a second left sleeve (201d). Right X-member (202) may be comprised of a first right sub-member (202a), or upper partial X-shaped member, and a second right sub-member (202b), or lower partial X-shaped member. First right sub-member (202a) may be further comprised of a first right sleeve (202c) and second right sleeve (202d).

Similar to single bass drum rack (100), double bass drum rack (200) may also be comprised of a tubular shaped material. In an exemplary embodiment, double bass drum rack (200) may largely be comprised of tubular steel and Chromalloy materials; and each portion where a sleeve (including 201c, 201d, 202c, and 202d) is located may be comprised of Chromalloy, which may be welded to the tubular steel material that forms the remaining sections of double bass drum rack (200).

First left sleeve (201c) of left X-member (201) is configured to house first left sub-member (201b). Both first left sleeve (201c) and first left sub-member (201a) may each contain two circular openings on opposite sides of its width (not shown) so that when first left sub-member (201a) is inserted into first left sleeve (201c), the pairs of circular openings may be lined up so that pin clip (110) may be inserted therein to fasten each of first left sub-member (201a) and first left sleeve (201c) together. Similarly, first right sleeve (202c) of right X-member (202) is configured to house second right sub-member (202b) in the same fashion as explained with respect to first left sleeve (201c).

Second left sleeve (201d) extends laterally out from first left sub-member (201a). Similarly, second right sleeve (202d) extends laterally out from first right sub-member (202a). Second left sleeve (201d) houses left leg member (203) and second right sleeve (202d) houses right leg member (204), in the same manner as explained above via circular openings through which pin clips (110) are inserted.

As explained with respect to single bass drum rack (100), each component of double bass drum rack (200), namely, first and second left sub-members (201a, 201b) and first and second right sub-members (202a, 202b), left leg member (203), and right leg member (204) are all angled and/or slanted in positioned. The slanted angles of each component allow for the force from the drum set to be displaced through left and right X-members (201, 202) and left and right leg member (203, 204). Further, as previously noted, the enhanced displacement of force from the drums can eliminate sliding, twisting, and ancillary forward or lateral movements in the double bass drum rack (200) and the drum set connected thereto. As explained with respect to single bass drum rack (100), double bass drum rack (200) may avoid the use of cross-bars as to allow for forces from the drum set to be more easily directed down to the ground/floor area.

In an exemplary embodiment of double bass drum rack (200), left and right X-members (201, 202) may each have lengths of approximately 44.5 inches, and heights (measured along first left and right sub-members (201a, 202a)) of approximately 48 inches. The length above the intersecting portion of the “X” shape of left and right X-members (201, 202) may be approximately 6 inches, and the height measured from the intersection portion of the “X” shape of left and right X-members (201, 202) to the ground may be approximately 33 inches. Further, the measurement beginning at left and right X-members (201, 202) to the length of either left and right leg members (203, 204) may be approximately 56 inches. Yet further, double bass drum rack (200) may have differing dimensions without deviating from the scope of the present invention, and may be sized to be used with, for example, a cocktail drum set or a percussion drum set.

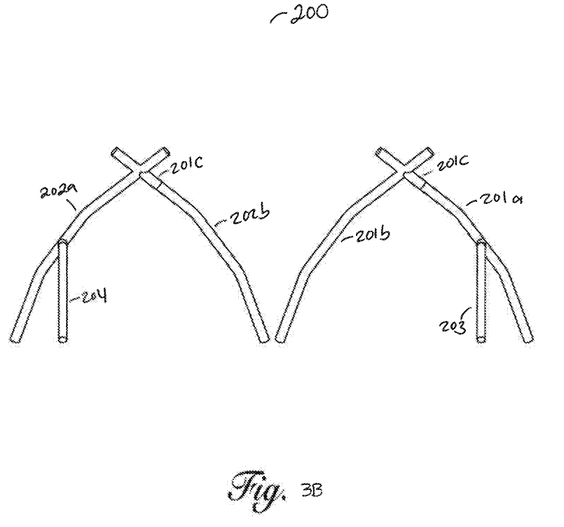

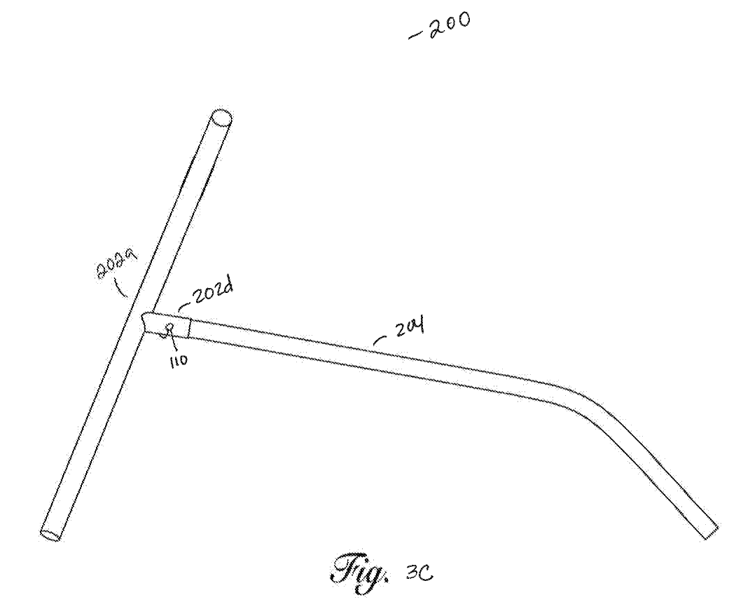

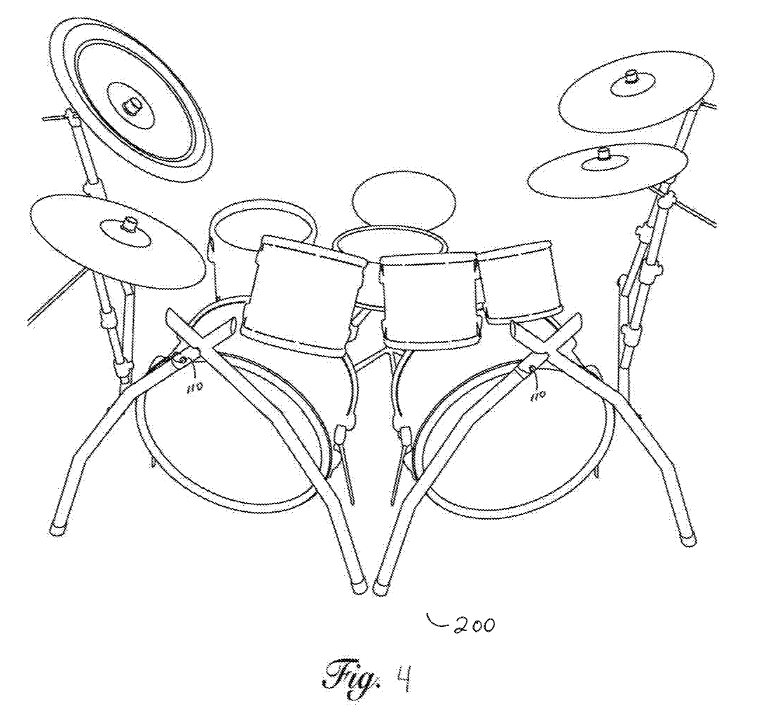

FIG. 4 illustrates an embodiment of the double bass drum rack (200) as used with a drum set. Left X-member (201) may be positioned in front/side of a left bass drum, and right X-member (202) may be positioned in front/side of a right bass drum. As can be seen in FIG. 4, left leg member (203) is situated on the left hand side of a left bass drum, and right leg member (204) is situated on the right hand side of a right bass drum. A user may use standard rack clamps, mounting hardware, and other drum connectors known in the industry to connect the drum set to double bass drum rack (200) according to a user's preference in placement of their drum set. For example, a user may connect the drum set to left and right X-members (201, 202), left leg member (203), and/or right leg member (204). Furthermore, depending on a user's preferences, a user may choose to use only left X-member (201) or only right X-member (202) in connection with a single bass drum set instead of single bass drum rack (100).

FIG. 5 illustrates a disassembled view of an embodiment of a single bass drum rack (100). Depending on a user's preference, a user may first connect second sub-member (103) to first sub-member (102) via first sleeve (102a) with the use of pin clips (110). Thereafter, a user may connect first leg member (104) to second sleeve (102b), and second leg member (105) to sleeve (103a) via use of pin clips (110). In the exemplary embodiment of single bass drum rack (100), three pin clips (110) may be required for assembly, and which also allow for ease in assembling or disassembling single bass drum rack (100) with minimal set-up pieces.

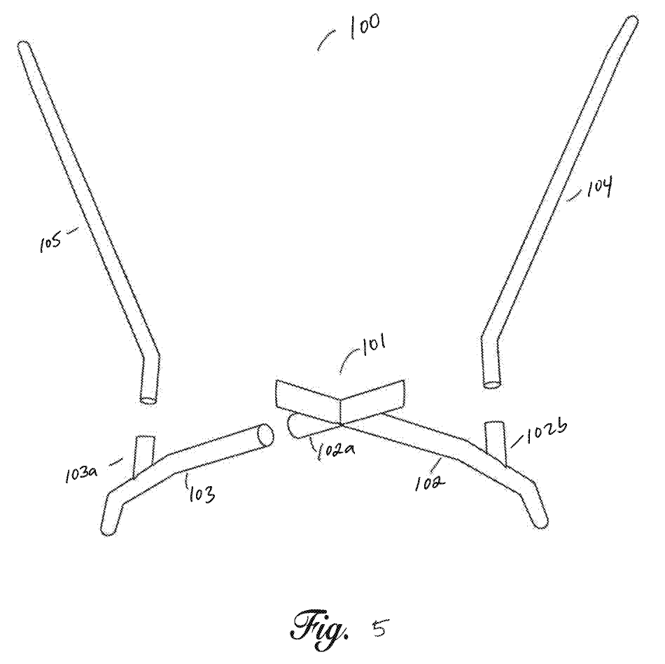

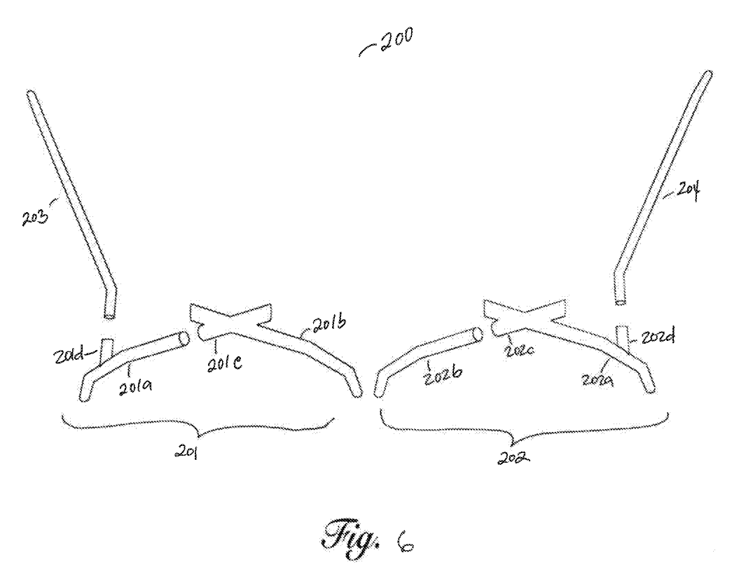

FIG. 6 illustrates a disassembled view of an embodiment for a double bass drum rack (200). Depending on a user's preference, a user may first connect first left sub-member (201a) to second left sub-member (201b) via first left sleeve (201c) with the use of pin clips (110). A user may then connect left leg member (203) to first left sub-member (201a) via second left sleeve (201d) with the use of pin clips (110). Thereafter, a user may connect second right sub-member (202b) to first right sub-member (202a) via first right sleeve (202c) and the use of pin clips (110). A user may then connect right leg member (204) to first right sub-member (202a) via second right sub-member (202b) and the use of pin clips (110). In the exemplary embodiment of double bass drum rack (200), four pin clips (110) may be required for assembly, and which also allow for ease in assembling or disassembling double bass drum rack (200) with minimal set-up pieces.

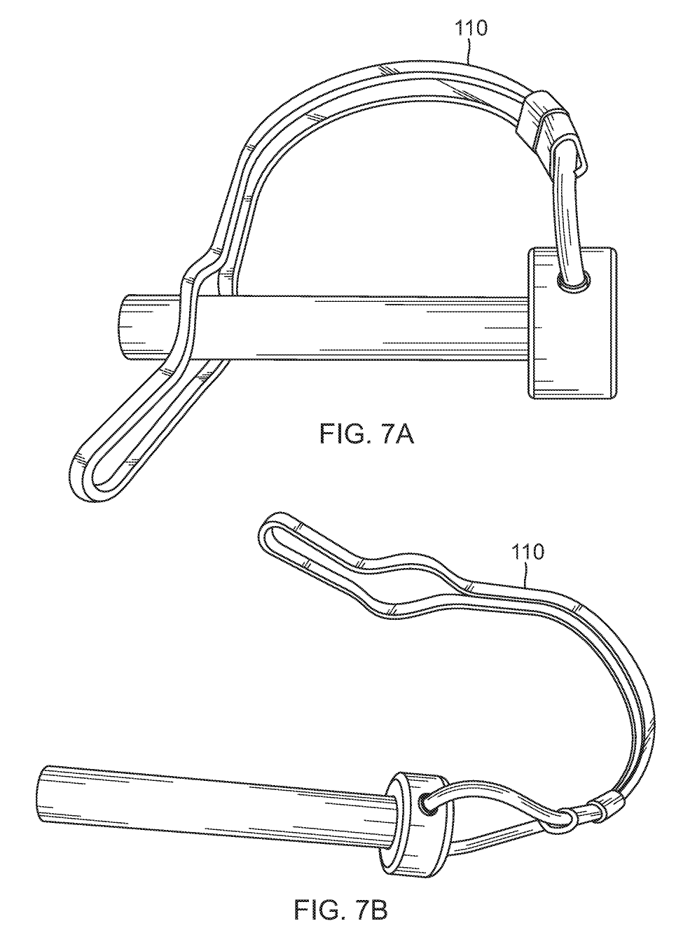

FIGS. 7A-B illustrates a close-up view of an embodiment of a pin clip (110) for use with single bass drum rack (100) and double bass drum rack (200) for a single or double bass drum set. As discussed earlier, the pin portion of pin clip (110) may be inserted into any of sleeves and X-member or leg supports. Once inserted there through, the clip portion of pin clip (110) may be wrapped around the body of the applicable sleeve and fastened around the opposite end of the pin portion that protrudes from the opposite side of the sleeve from where pin clip (110) was inserted. In alternate embodiments, other fastening mechanisms may be employed, including single pins and screws.

Various aspects of the present invention are described herein with reference to illustrations and/or diagrams according to embodiments of the invention. While particular forms of the invention have been illustrated and described, it will also be apparent to those skilled in the art that various modifications can be made without departing from the spirit and scope of the invention. Accordingly, it is not intended that the invention be limited except by the claims.

1. A rack for a single bass drum set, comprising:
a generally X-shaped support member;
wherein said X-shaped support member further comprises an upper partial X-shaped member and a lower partial X-shaped member;
and further wherein, said upper partial X-shaped member contains at least one outwardly curving portion, and wherein said lower partial X-shaped member contains at least one outwardly curving portion;
a first support leg removably coupled to said upper partial X-shaped member via a first sleeve coupled to said upper partial X-shaped member; and
a second support leg removably coupled to said lower X-shaped member via a second sleeve coupled to said lower X-shaped member.

2. The rack of claim 1, wherein the X-shaped support member, first support leg, and second support leg are comprised of hollow tubular steel.

3. The rack of claim 1, wherein the X-shaped support member, first support leg, and second support leg are comprised of hollow chromalloy.

4. The rack of claim 1, wherein said first sleeve contains a plurality of circular openings situated in a parallel configuration to each other on opposite sides of said first sleeve.

5. The rack of claim 4, wherein said first support leg contains a plurality of circular openings situated in a parallel configuration to each other on opposite sides of said first support leg.

6. The rack of claim 1, wherein said second sleeve contains a plurality of circular openings situated in a parallel configuration to each other on opposite sides of said second sleeve.

7. The rack of claim 6, wherein said second support leg contains a plurality of circular openings situated in a parallel configuration to each other on opposite sides of said second support leg.

8. The rack of claim 5, wherein said first sleeve may be permanently fastened to said first support leg via a first pin clip inserted through said circular openings of said first sleeve and said first support leg.

9. The rack of claim 7, wherein said second sleeve may be permanently fastened to said second support leg via a second pin clip inserted through said circular openings of said second sleeve and said second support leg.

10. A rack for a double bass drum set, comprising:
a first X-shaped support member;
wherein said first X-shaped support member further comprises a first upper partial X-shaped member and a first lower partial X-shaped member;
and further wherein, said first upper partial X-shaped member contains at least one outwardly curving portion, and wherein said first lower partial X-shaped member contains at least one outwardly curving portion; and
a first support leg removably coupled to said first partial lower X-shaped member via a first sleeve coupled to said first lower X-shaped member;
a second X-shaped support member;
wherein said second X-shaped support member further comprises a second upper partial X-shaped member, and a second lower partial X-shaped member;
and further wherein, said second upper partial X-shaped member contains at least one outwardly curving portion, and wherein said second lower partial X-shaped member contains at least one outwardly curving portion; and
a second support leg removably coupled to said second upper partial X-shaped member via a second sleeve coupled to said second upper X-shaped member.

11. The rack of claim 10, wherein the first X-shaped support member, second X-shaped support member, first support leg, and second support leg are comprised of hollow tubular steel.

12. The rack of claim 10, wherein said first support leg contains a plurality of circular openings situated in a parallel configuration to each other on opposite sides of said first support leg.

13. The rack of claim 12, wherein said first sleeve contains a plurality of circular openings situated in a parallel configuration to each other on opposite sides of said first sleeve.

14. The rack of claim 10, wherein said second support leg contains a plurality of circular openings situated in a parallel configuration to each other on opposite sides of said second support leg.

15. The rack of claim 14, wherein said second sleeve contains a plurality of circular openings situated in a parallel configuration to each other on opposite sides of said second sleeve.

16. The rack of claim 13, wherein said first sleeve may be permanently fastened to said first support leg via a first pin clip inserted through said circular openings of said first sleeve and said first support leg.

17. The rack of claim 15, wherein said second sleeve may be permanently fastened to said second support leg via a second pin clip inserted through said circular openings of said second sleeve and said second support leg.
